(19) United States
(12) Patent Application Publication
(10) Pub. No.: US 2021/0368735 A1
(43) Pub. Date: Dec. 2, 2021

(54) House Shaped Shelter For Animals

(71) Applicant: Michael Gene Faeth, Fresno, CA (US)

(72) Inventor: Michael Gene Faeth, Fresno, CA (US)

(21) Appl. No.: 16/822,581

(22) Filed: Jun. 1, 2020

(51) Int. Cl. A01K 1/03; A01K 1/00

(52) U.S. Cl. CPC A01K 1/033; A01K 1/0035

(57) ABSTRACT

A single-piece containerboard blank (7) is provided having hingedly-connected first (8), second (9), third (10) and fourth (11) side walls, in which the first side wall is long enough in length to be folded back over the entire structure and function as a roof (6). This side wall includes hingedly-connected sections and slots (1) cutouts for tabs to insert into. The first side wall also has hingedly-connected sections (5) and creases to allow easy folding (3). The third wall includes a hole (2) to function as a door. The second and third side walls include tabs (4) that can be used to fit into the slots located on the first side wall.

### FIELD OF THE INVENTION

The present invention relates to animal shelters, and more particularly, to animal shelters formed from a single blank that allows art to be added to the completed structure.

### BACKGROUND OF THE INVENTION

In the animal shelter art there are many designs that are manufactured for various end uses. One popular end use for an animal house is for shelter either to be used outdoors or indoors for the animal. Such shelters are generally a variety of different shapes. A well known shape is that which mimics the shape of a house. Being able to create a house shape from a single blank will reduce the amount of pieces needed to form a completed shelter. Using material that will easily accept paint and other art materials allows for the end user to create their own designs.

### SUMMARY OF THE INVENTION

The present invention is directed to an animal shelter created from a single piece of material, which is cut into a particular shape including scores for folding and holes included which align with tabs. In accordance with the present invention, a single piece containerboard blank is provided for forming an animal shelter having an A-frame shaped design and at least one door for the animal to enter and exit the structure. The blank includes a bottom floor and four walls hingedly connected having fold lines. One wall includes a tab and is flat on top. Another wall includes a door, includes two tabs and is angled where the center is taller than the sides. Another wall is solid, includes two tabs and is angled where the center is taller than the sides. The last wall is hingedly connected using a fold line to an extended area that becomes the roof when the structure is completely constructed. The roof area includes holes that allow the tabs on the sides to engage the roof and secure it to the sides.

### BRIEF DESCRIPTION OF THE DRAWINGS

The foregoing aspects and many of the advantages of this invention will become more readily appreciated and become better understood by reference to the following detailed description, when taken in conjunction with the accompanying drawings, wherein:

FIG. 1 is a plan view of a blank from which the animal shelter is formed;

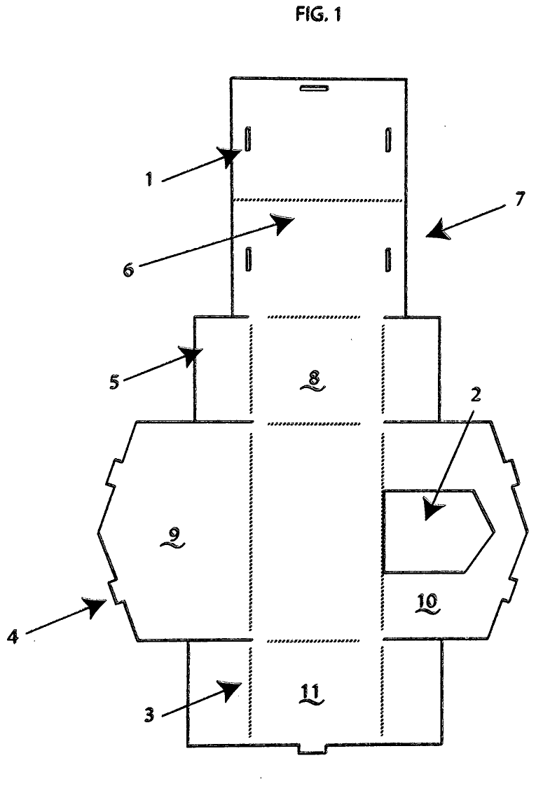

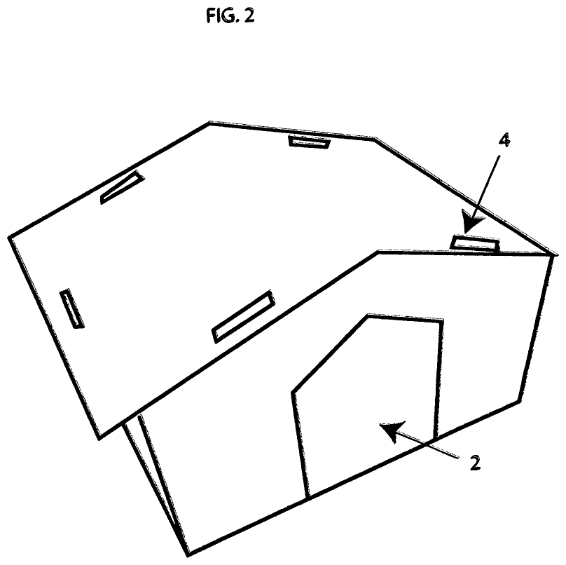

Reference line 1 shows the holes cut into the roof of the structure wherein the tabs on the walls engage into the roof;

Reference line 2 shows the cut-out door of the shelter;

Reference line 3 shows a scored area with dotted lines where fold lines allow hingedly connected areas of the single blank

Reference line 4 shows a tab on a wall that is angled where the center is taller than the sides

Reference line 5 shows a hingedly connected part of a wall that folds up inside of the completed structure

Reference line 6 shows the roof area of the single blank that is hingedly connected to a wall having a fold line at top

Reference line 7 shows the a single-piece containerboard

Reference line 8 shows a first sidewall hingedly-connected

Reference line 9 shows a second sidewall hingedly-connected

Reference line 10 shows a third side wall hingedly-connected

Reference line 11 shows a fourth side wall hingedly-connected

FIG. 2 is a drawing of the fully constructed shelter shown from the frontal view that shows the door of the shelter, A-frame shape, and surface areas that easily accept art materials such as paint, markers, etc.

1. A single-piece containerboard blank erectable into a house shaped shelter having four walls, at least one entry opening, an A-frame style roof and a floor area.

2. The single-piece blank according to claim 1, wherein the floor area has a section cutout to allow for animal droppings to fall outside of the structure.

3. The single-piece blank according to claim 1, wherein the roof area has a section hingedly-connected that can be lifted up to peer into the structure and closed again.

4. The single-piece blank according to claim 1, wherein the surface of the structure is made of a material that easily accepts paint, markers of other means of adding custom art to the shelter
